(19) United States
(12) Patent Application Publication
(10) Pub. No.: US 2011/0297106 A1
(43) Pub. Date: Dec. 8, 2011

(54) LEASH, COLLAR, AND HARNESS WITH INTERCHANGEABLE ACCESSORIES

(76) Inventor: Andrea J. Kaplan, North Miami Beach, FL (US)

(21) Appl. No.: 13/153,182

(22) Filed: Jun. 3, 2011

Related U.S. Application Data
(60) Provisional application No. 61/352,060, filed on Jun. 7, 2010.

(51) Int. Cl. A01K 27/00

(52) U.S. Cl. 119/798

(57) ABSTRACT

A leash for animals incorporating a flexible strap formed of a closed-cell, cross-linked, thermoset foamed polymer having structure for attachment to the animal's neck at one end and a loop or handle for the animal's handler at the other end. A plurality of apertures formed along the length of the strap allow decorative elements such as charms to be attached to the leash.

### CROSS-REFERENCE TO RELATED APPLICATIONS

This application claims priority of U.S. Provisional Patent Application No. 61/352,060 filed Jun. 7, 2010, the contents of which are incorporated herein by reference.

### FIELD OF THE INVENTION

This invention relates to leashes for animals and more particularly to a leash formed of unique material with the strap portion configured to support decorative accessories.

### SUMMARY OF THE INVENTION

The present invention is directed to a leash for animals incorporating a flexible strap formed of a closed-cell, cross-linked, thermoset foamed polymer having structure for attachment to the animal's neck at one end and a loop or handle for the animal's handler at the other end. A plurality of apertures formed along the length of the strap allow decorative elements such as charms to be attached to the leash.

### BRIEF DESCRIPTION OF THE DRAWINGS

Other aspects and advantages of the present invention will be made clear by the following detailed description which makes reference to the accompanying drawings, in which:

FIG. 1 is a perspective view of a preferred embodiment of a leash formed in accordance with the present invention;

FIG. 2 is a detailed view of one end of the leash of FIG. 1 incorporating a fastener for attachment to an animal collar;

FIG. 3 is a detailed view of sections of the leash strap incorporating apertures for receiving decorative accessories;

FIGS. 4a and 4b are drawings of preferred forms of decorative accessories for attachment to the leash strap;

FIG. 5 illustrates two embodiments of the invention, one with, and the other without, decorative accessories; and

FIG. 6 is a picture of a dog wearing an embodiment of the invention.

### DETAILED DESCRIPTION OF THE INVENTION

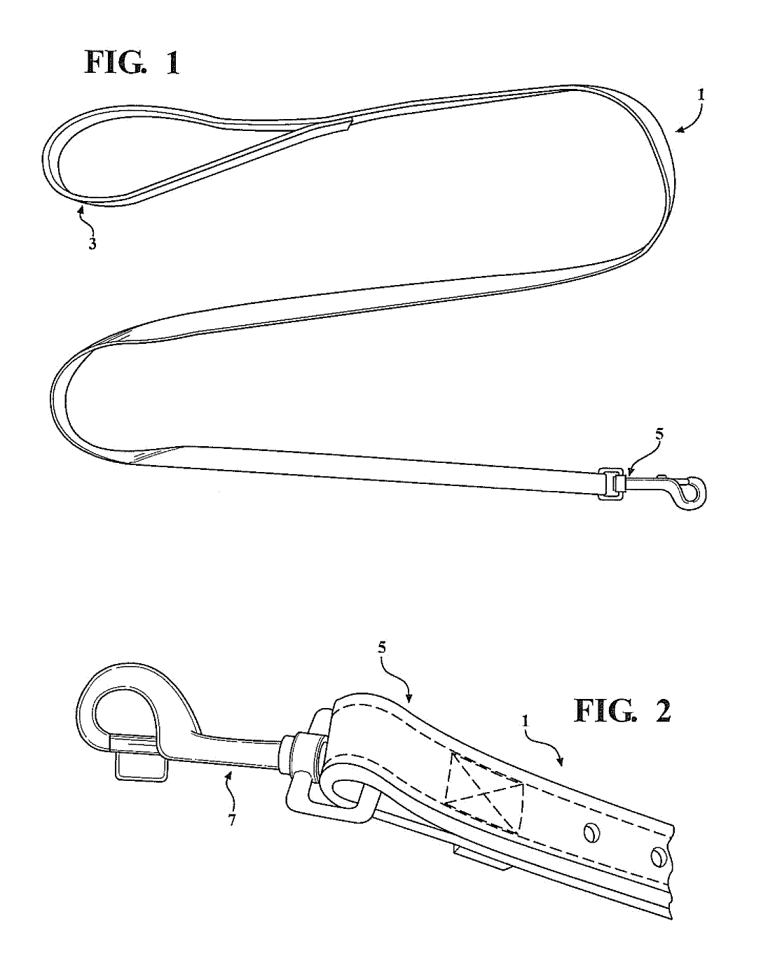

Referring to the drawings, one aspect of the present invention comprises a leash 1 having a first end 3 and a second end 5. The length of leash 1 may vary in size from just a few inches to several feet, and such dimension should not be construed as limiting for the purposes of the instant disclosure. Additionally, the width of the leash may vary as desired, it being understood that a wider leash permits the user to apply greater force when handling the subject animal. As shown in FIG. 1, the first end 3 of leash 1 is the “free end” that the handler holds. Accordingly, first end 3 may have a loop, handle, or other similar structure known in the art that permits the handler to maintain a solid grasp on leash 1. Second end 5 of leash 1 is intended to be secured to the pet. With reference to FIG. 2, second end 5 may have a fastening means 7 such that leash 1 of the present invention can be secured to a pet's collar. Such fastening means may include carabineers, spring-loaded clasps, D-rings, O-rings, or their equivalents.

In some embodiments, second end 5 may be a simple “slip lead” that is not secured to a collar, but rather comprises a ring that is capable of receiving first end 3 of leash 1, creating a slipknot around the pet's neck. A “slip lead” may also be created by other means, such as by wrapping a portion of second end 5 around the pet's neck and securing a spring-loaded clip at the end of second end 5 to the free end of leash 1. Additional means and methods for securing the present invention to the pet are well known in the art and the foregoing shall not be construed as limiting.

In some embodiments, leash 1 of the present invention may be comprised of a resin-based foam material made of ethylene vinyl acetate. Such material is preferably nontoxic, antimicrobial, and resistant to odor, bacterial growth, and fungal growth. Additionally, such material is preferably highly impact resistant and durable. In some embodiments, leash 1 may be relatively elastic; however, depending on the density of the leash material and/or the relative cross-sectional dimensions of leash 1, leash 1 may be relatively inelastic. Preferably, such material comprises a closed-cell, cross-linked, thermoset polymer foam such as an ethylene elastomer, preferably molded. In certain embodiments the polymer may be EVA or an olefin. The material has antiseptic properties by virtue of its closed-cell surface which does not provide an absorbant harbor for bacteria as would prior art leather leashes.

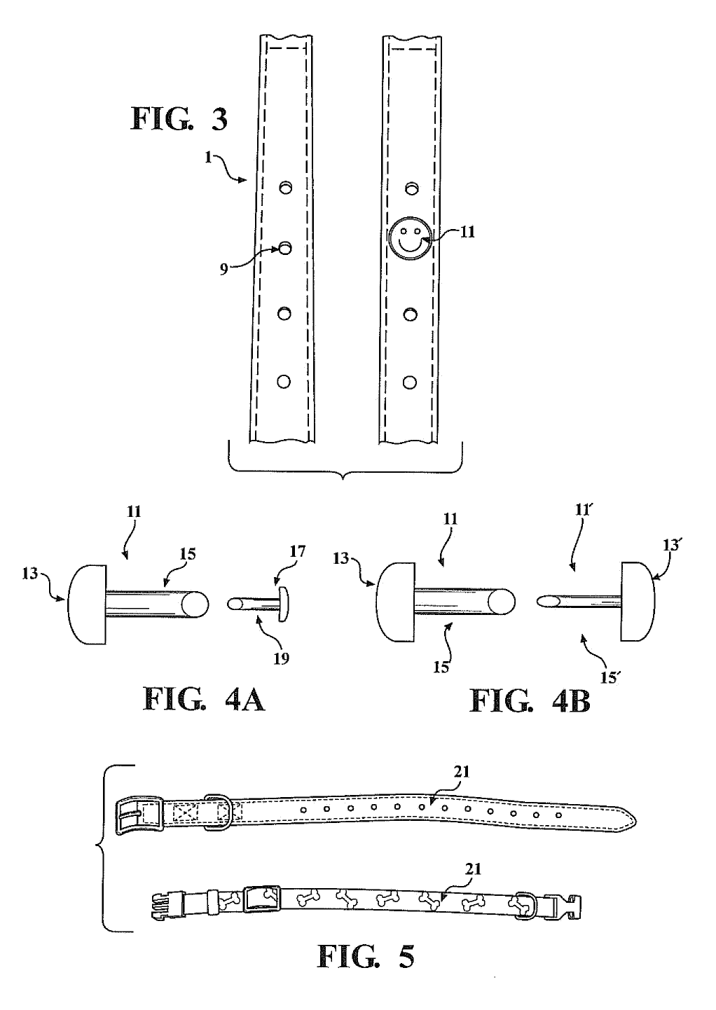

In some embodiments of the present invention, leash 1 may have one or more apertures 9 along the length thereof which are capable of receiving a variety of modular, interchangeable accessories 11, as shown in FIG. 3. Such accessories 11 may include, for example, decorative attachments, i.e. “charms”, and the like. With reference to FIG. 4a, in some embodiments, accessory 11 comprises a decorative element 13 with an elongated protrusion 15 extending therefrom. Accordingly, the apertures 9 are capable of receiving the distal end of protrusion 15 such that accessory 11 is attached to leash 1. Accessory 11 may be secured to leash 1 by stop 17 which is designed to interlock with the distal end of protrusion 15. For example, protrusion 15 may comprise a hollow shaft or cylinder extending from decorative element 13 creating the “female” portion of the interlocking combination. Accordingly, in some embodiments, stop 17 has a small tang 19 that is the “male” portion of the interlocking combination. In some embodiments the male “tang” may have striations or ribbing extending outwardly therefrom to further secure the male-female interlocking combination. In some embodiments, stop 17 at its proximal end may have a small disc or similar element such that when the “male” portion of stop 17 is interlocked with the “female” portion of protrusion 15, accessory 11 is secured snugly to both sides of aperture 9 and thus to leash 1. Of course, in some embodiments, protrusion 15 may comprise the “male” tang and stop 17 may comprise the “female” shaft or cylinder. Additional interlocking joints or mechanisms known in the art may be equally suitable. For example, snaps or buttons may be feasible depending on the relative size and shape of the accessory 11. Further, a ball-and-socket combination may also be employed substantially as described above.

In some embodiments, stop 17 may be replaced with another accessory 11′ having a decorative element 13′ such that both sides of the leash have decorative features, as shown in FIG. 4b. For example, protrusion 15 of accessory 11 may comprise the “female” shaft or cylinder and protrusion 15′ of accessory 11′ may comprise the “male” tang such that the two protrusions are capable of interlocking. Of course, in alternative embodiments protrusion 15′ may comprise the “female” shaft or cylinder and protrusion 15 comprises the “male” tang. In some embodiments, accessory 11′ is designed such that it is compatible with existing accessories 11 having decorative elements 13. In one embodiment, such an accessory 11′ may comprise a “keyhole” arrangement that is capable of receiving and retaining the disc-shaped protrusion of an existing accessory 11. In some embodiments, such an accessory 11′ may also have decorative elements 13′ as described herein.

Decorative element 13 may comprise a variety of decorative features as desired by the user. In some embodiments, decorative element 13 need not be a planar element, but rather could comprise any variety of other decorative elements known in the art that may extend outward from the proximal end of accessory 11 (or 11′). Such elements may include, but are not limited to, rounded elements such as game balls; sports balls; figurines such as human figures, cartoon figurines, dogs, cats, or other animals; and flowers such as sunflowers, roses, and the like. Any decorative element 13 may be incorporated provided it is sized such that it is capable of being integrated into accessory 11. Further, decorative element 13 may be comprised of any suitable material such as plastic, PVC, metal, resin, and the like.

In addition to leash 1 of the present invention, the present invention may also comprise a collar 21 having the same elements as described above, namely, apertures 9 that are capable of receiving accessories 11. In some embodiments, collar 21 is made of the resin-based foam material described above and may include a variety of closure means known in the art such as clips or belt closures. Further, collar 21 may have a fabric lining on the inside to provide a layer of comfort and warmth for the subject animal wearing the collar. Such fabric may include cotton, fleece, wools, and other suitable natural and/or synthetic material. Exemplary collars are shown in FIG. 5.

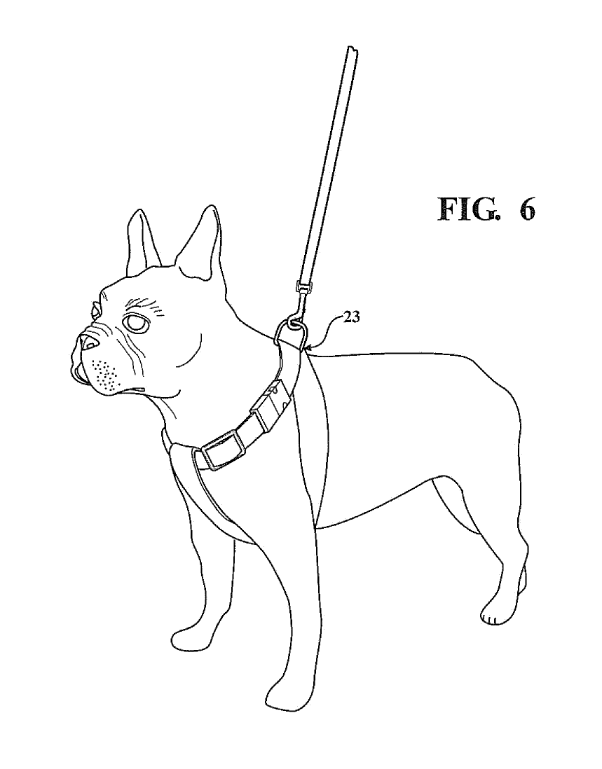

Further, the present invention may also comprise a harness 23 having the same elements as described above, namely, apertures 9 that are capable of receiving accessories 11. In some embodiments, harness 23 is made of the resin-based foam material described above and may include a variety of closure means known in the art such as clips or belt closures. Further, harness 23 may have a fabric lining on the inside to provide a layer of comfort and warmth for the subject animal wearing the collar. Such fabric may include cotton, fleece, wools, and other suitable natural and/or synthetic material. An example of a harness is shown in FIG. 6.

In the foregoing description, the present invention has been described with reference to specific exemplary embodiments thereof. It will be apparent to those skilled in the art that a person understanding this invention may conceive of changes or other embodiments or variations which utilize the principles of this invention without departing from the broader spirit and scope of the invention. The specification and drawings are, therefore, to be regarded in an illustrative rather than a restrictive sense.

Having thus described my invention I claim:

1. A leash for allowing a handler to control an animal, comprising:
an elongated flexible strap formed of a closed-cell, cross-linked, thermoset foamed polymer;
structure at a first end of the strap for engagement with the neck of the animal;
structure at a second end of the strap for grasping by the handler; and
regularly spaced apertures formed along the length of the strap for retention of decorative accessories for the leash.

2. The leash of claim 1, wherein the decorative accessories have shanks adapted to be inserted into said apertures.

3. The leash of claim 1, wherein the strap is formed by molding the polymer.

4. The leash of claim 1, wherein the strap has antiseptic properties.
